(19) United States
(12) Patent Application Publication
(10) Pub. No.: US 2016/0353256 A1
(43) Pub. Date: Dec. 1, 2016

(54) ASSIGNING TARGET ENTITIES TO MEMBERS OF A GROUP BASED ON SOCIAL PROXIMITY

(71) Applicant: LinkedIn Corporation, Mountain View, CA (US)

(72) Inventors: John Chao, Foster City, CA (US); Liangjie Hue, Mountain View, CA (US); Huan Hoang, San Jose, CA (US); Wenjing Zhang, Menlo Park, CA (US); Michael Miller, San Francisco, CA (US); Josh VanGeest, Sunnyvale, CA (US); Qiang Zhu, Sunnyvale, CA (US)

(21) Appl. No.: 14/722,150

(22) Filed: May 27, 2015

(51) Int. Cl. H04W 4/08; H04W 4/02; G06F 17/30

(52) U.S. Cl. CPC H04W 4/08; G06F 17/3053; H04W 4/023

(57) ABSTRACT

Techniques are provided for assigning members of a group to multiple target entities. A social proximity score is generated that reflects a measure of social relatedness between a group member and a target entity. Generated social proximity scores and one or more constraints are specified or referenced by a program. The program seeks to maximize social proximity scores in light of the one or more constraints. A solver executes the program to generate a result that assigns each target entity to at least one (or no more than one) group member.

### CROSS-REFERENCE TO RELATED APPLICATIONS

This application is related to U.S. patent application Ser. Nos. 13/781,408 and 13/781,569, both filed Feb. 28, 2013, the entire contents of both of which is hereby incorporated by reference for all purposes as if fully set forth herein.

### TECHNICAL FIELD

The present disclosure generally relates to data processing systems and, more specifically, to methods, systems, and computer program products for use in analyzing a social graph of a social network service and assigning members of a group to various target entities based on how socially connected each member is to each target entity.

### BACKGROUND

The success of any business organization depends largely on the effectiveness of the organization's sales team. A business organization with excellent manufacturing operations, cutting-edge technology, tight financial goals, and progressive management techniques will still struggle if it lacks an effective sales mechanism. At least one aspect that impacts the overall effectiveness of a sales team is the manner in which sales resources—that is, the individual members of the sales team (commonly referred to as sales representatives)—are allocated or assigned to the various customer accounts of the business organization. One approach regarding the allocation of sales resources typically focuses on one or more market segmentation techniques. For example, many business organizations segment a target market into different geographical regions and then allocate sales representatives to manage customer accounts based on the geographical region of the customer and the sales representatives. While such a technique may prove more effective than randomly allocating customer accounts to sales representatives, more effective techniques for allocating sales resources are desirable.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for assigning members of a group to multiple target entities, in an embodiment;

FIG. 2 is a flow diagram that depicts a process for assigning members of a group to multiple target entities, in an embodiment;

FIG. 3 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Systems and methods are provided for automatically assigning members of a group to various target entities based on each member's social proximity to one or more people associated with the target entities. For example, if a group member is directly connected, in a social network, with a person associated with a target entity, then that group member should be assigned to the target entity. A social proximity score (SPS) is generated for each group member-target entity pair. The SPS is used to determine which group members should be assigned to which target entities.

In one technique, a problem that seeks to maximize SPS given a group of members and a set of target entities is expressed in a program composed in a programming language. The program specifies one or more constraints, such as a certain percentage of accounts being in the same time zone as a group member user. A solver accepts the program as input and generates a result that assigns each target entity to a group member according to the one or more constraints specified in the program.

### System Overview

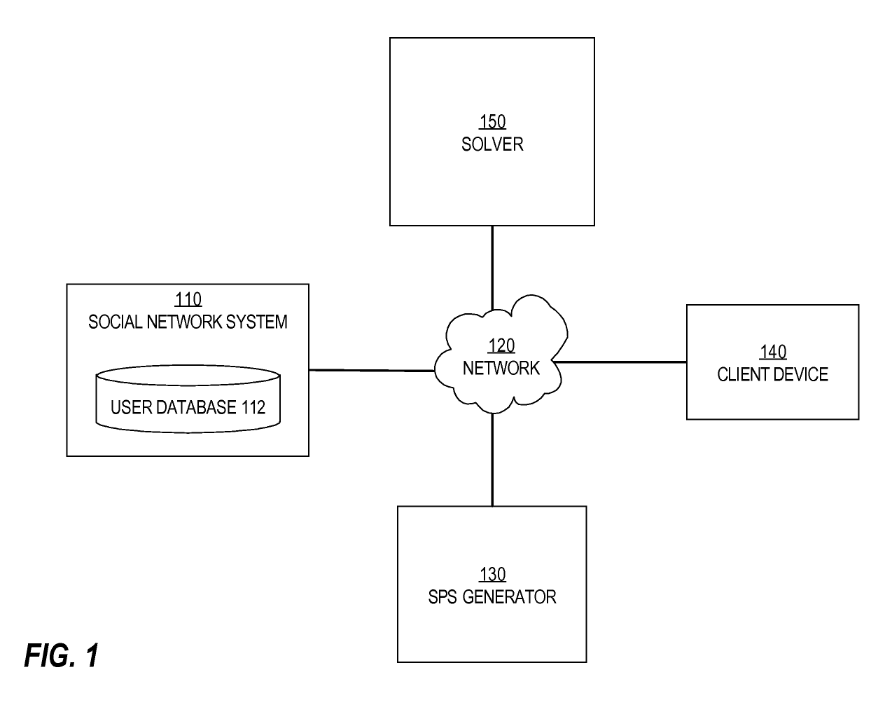

FIG. 1 is a block diagram that depicts a system 100 for assigning members of a group to multiple target entities, in an embodiment. System 100 includes a social network system 110, a network 120, a social proximity score (SPS) generator 130, a client device 140, and a solver 150.

Social network system 110 includes a user database 112 that indicates, for each user, (1) profile data that indicates one or more profile attributes of the user and (2) connection data that indicates one or more other users to which the user is connected. Two users in social network system 110 may be considered “connected” to each other if one user initiated an invitation to connect and the other user accepted the invitation. Thereafter, each user may view the profile data of the other user and/or network activities of the other user.

In an embodiment, users that are not “connected” to each other are able to view the profile data of the other. However, such “unconnected” users may be able to view only a portion of each other's profile data. The amount of profile data that one user may view of another may be inversely proportional to how closely connected the two users are in a social graph. For example, a particular user that has a second degree connection with a first user may be able to see 75% of the first users profile but only 50% of a profile of second user with whom the particular user has a third degree connection.

Social network system 110 is implemented on one or more computing devices that may reside in the same network or may be distributed across multiple networks.

Network 120 may be implemented on any medium or mechanism that provides for the exchange of data between social network system 110 and SPS generator 130, between SPS generator 130 and client device 140, and between client device 140 and solver 150. Examples of network 120 include, without limitation, a network such as a Local Area Network (LAN), Wide Area Network (WAN), Ethernet or the Internet, or one or more terrestrial, satellite or wireless links.

SPS generator 130 is configured to generate a SPS (described in more detail below) relative to two entities based on relevant connection data and, optionally, relevant profile data. Given the identities of the two entities, SPS generator 130 analyzes the connection data of at least one of the entities to determine whether that entity is connected to the other entity. If not, then SPS generator 130 may analyze the connection data of both entities to determine whether the two entities have a common connection. If so, then the two entities are considered second degree connections of each other. If not, then SPS generator 130 may analyze the connection data of each connection of one of the entities to determine whether the two entities are third degree connections of each other. If SPS generator 130 determines that the two users are not at least second or third degree connections of each other, then SPS generator 130 generates a zero or other value for the SPS that indicates that the two entities are not connected.

SPS generator 130 may be implemented in software, hardware, or a combination of software and hardware. While SPS generator 130 is depicted separately from social network system 110, SPS generator 130 may be implemented as part of social network system 110.

Client device 140 is a computing device that a user employs to compose a program in a particular problem modeling language. Examples of client device 140 include a desktop computer, a laptop computer, a tablet computer, and a smartphone. An objective of the program composed by client device 140 is to maximize social proximity scores among group members and target entities given one or more constraints. Client device 140 may execute a dedicated application or a web application that is configured to display a user interface for specifying the program. For example, solver 150 may execute a web server that provides a web page (for composing the program) in response to a request from client device 140.

The program includes, for each member in a group, a set of SPSs (generated by SPS generator 130), one SPS for each target entity. Alternatively, the program refers to a file or other source that includes the set of SPSs for each member in the group.

Embodiments are not limited to the type of programming language used to compose the program. One example programming language is AMPL or “A Mathematical Programming Language.” AMPL is an algebraic modeling language for describing and solving high-complexity problems for large-scale mathematical computation, such as large-scale optimization and scheduling-type problems). AMPL supports dozens of solvers, both open source and commercial, including CPLEX (IBM ILOG CPLEX Optimization Studio), FortMP, Gurobi, MINOS (Modular In-core Nonlinear Optimization System), IPOPT (Interior Point Optimizer), SNOPT (Sparse Nonlinear Optimizer), and KNITRO (Nonlinear Interior point Trust Region Optimization). AMPL supports three file types: .mod file for the model, .dat file for the data, and .run file for flow control

An advantage of AMPL over other programming languages is the similarity of its syntax to the mathematical notation of optimization problems. This similarity allows for a very concise and readable definition of problems in the domain of optimization.

Client device 140 may also be used to communicate with SPS generator 130. Client device 140 may execute a dedicated application or a web application that is configured to display a user interface for specifying information about group members and target entities. For example, SPS generator 130 may execute a web server that provides a web page (for specifying entity identifiers) in response to a request from client device 140. The user interface may allow a user of client device 140 to specify a list (or a file that includes a list) of names or IDs of group members and target entities that SPS generator 130 needs to identify the respective entities in a social graph and generate social proximity scores.

Solver 150 accepts programs (or problem descriptions) as input and calculates their respective solutions. Specifically, solver 150 is configured to accept a program (composed using client device 140) and generate a result that maps group members to target entities. Each target entity is assigned to a single group member while a single group member may be assigned to multiple target entities. Solver 150 may include a (e.g., AMPL) modeling system and a computing engine. The modeling system analyzes one or more files and calls APIs of the computing engine in order to generate the assignment.

Solver 150 may be implemented in hardware, software, or any combination of hardware and software. While solver 150 is depicted as a single element, solver 150 may be implemented on multiple computing devices. Additionally, while solver 150 is depicted separate from social network system 110, solver 150 may be implemented within social network system 110. Alternatively, solver 150 may be implemented by a third party service relative to social network system 110 and/or SPS generator 130.

### Example Process

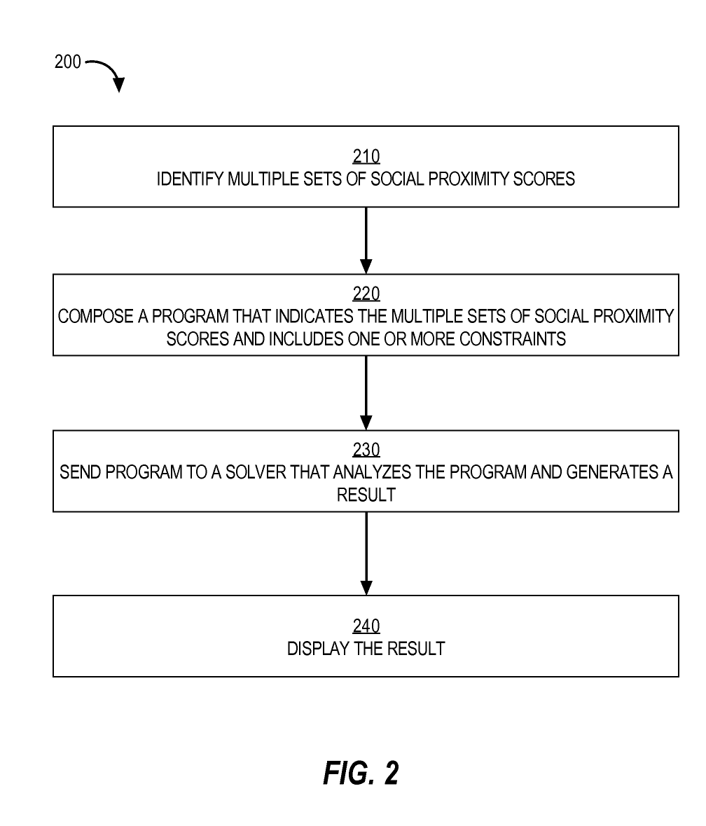

FIG. 2 is a flow diagram that depicts a process 200 for assigning members of a group to multiple target entities, in an embodiment. Process 200 may be implemented by one or more elements of system 100, such as social network system 110, SPS generator 130, and/or client device 140.

At block 210, a multiple sets of social proximity scores are identified. Each set is associated with a different member of a group of members. Each SPS in the set of SPSs corresponding to a member is associated with a different target entity of multiple target entities.

For example, there may be ten sales representatives of a sales team and one thousand customer accounts. A social proximity score is generated for each combination of sales representative and customer account. Thus, in this example, ten thousands social proximity scores are generated. The ten thousand SPSs may have been generated by SPS generator 130 based on input from client device 140.

At block 220, a program is composed. The program indicates the multiple sets of social proximity scores identified in block 210 and includes one or more constraints that are to be satisfied. Block 220 may involve receiving user input at client device 140 (or another computing device not depicted in FIG. 1), where the user input indicates the SPSs and the constraint(s).

At block 230, the program is sent to a solver that analyzes the program and generates a result. Block 230 may involve client device 140 sending the program over network 120 to solver 150. The result indicates, for each target entity of the multiple target entities, an association between that target entity and a member in the group.

At block 240, the result is displayed. Block 240 may involve client device 140 displaying the result in a web page rendered by a web browser of client device 140 or in a user interface generated by a dedicated application executing on client device 140.

### Social Proximity Score

A social proximity score (SPS) is a score (e.g., a number) that represents a measure of how socially connected an individual is to another entity represented in the social graph—such as a company, educational institution, government entity or organization, non-profit organization, or any other type of organization. By deriving social proximity scores for two or more people, the degree to which each person is connected or related to a particular target entity (e.g., a company) can be compared, thereby improving resource allocation decisions and techniques.

For example, a business organization is assigning a particular customer account to a sales representative of a sales team. The social proximity scores of the individual sales representatives can be compared with one another, such that the customer account is ultimately assigned to a sales representative that has a social proximity score that is generally higher than that of his or her peers, indicating a greater level of connectedness between the sales representative and the company representing the customer account.

One factor that may dictate how high (or low) a SPS is between an individual and a target entity is whether the individual is directly connected to an individual associated with the target entity. For example, an individual is directly connected with a decision maker of a first customer account and is indirectly connected (through one or more intermediate connections) with a decision maker of a second customer account. Thus, due to the direct connection, the user may have a higher SPS associated with the first customer account than with the second customer account. Generally, the closer the connection with a decision maker of a customer account, the higher the SPS.

A “decision maker” in an organization is a person who has significant influence in the organization. For example, a decision maker may be a person who can bind a first company to a contract with a second company. As another example, a decision maker may be a person who is closely connected (or related) to people who can so bind the first company. In a law firm, a decision maker may be a partner. In other types of organizations, a decision maker may be a director, VP, or officer. Example officers include a CEO (chief executive officer), a CXO (chief experience officer), a CFO (chief financial officer), a CCO (chief creative officer), a CTO (chief technology officer), or a CMO (chief marketing officer). Thus, the fact that a person is employed by an organization does not, by itself, make that person a decision maker within the organization.

Other attributes of an individual and a person associated with a target entity (other than whether they are a first or second degree connection) may be used to calculate a social proximity score. Such attributes are referred to herein as “non-connection attributes.” For example, the fact that an individual and an employee of a target entity both attended the same university may factor into the individual's social proximity score associated with the employee. As another example, the fact that an individual and a decision maker both worked for the same employer at the same time may boost the individual's social proximity score. As another example, if an individual and a decision maker both belong to the same charitable organization, then the social proximity score may be higher than if they did not belong to the same charitable organization.

Example non-connection attributes include previous and current employers, academic institutions attended, academic degrees earned, previous and current city/state/country of residence, skills, endorsers, languages spoken, personal interests, employment status, marital status, and people/companies/schools/other organizations that are followed.

Non-connection attributes may be stored as part of a user's profile in a social network. Additionally or alternatively, non-connection attributes may come from a source that is different than the source from which the connection information (e.g., first degree or second degree connection) is derived. For example, a news article may indicate that a decision maker associated with a target entity previously work at a particular company during a particular period of time. If a sales representative's profile indicates that the sales representative also worked at the particular company during the particular period of time, then that fact is used to generate a social proximity score with respect to the sales representative and the decision maker.

A social proximity score may be based on some weighted combination of a number of factors. For example, in generating a social proximity score, the number of first degree connections with a target entity may be weighted with a weighting factor to contribute more to the overall social proximity score than second-degree connections. As another example, connections to people employed with the target entity and satisfying certain criteria (e.g., job function, job title, seniority level, etc.) may be weighted more heavily than connections to people employed with the target entity, but not satisfying the criteria. Thus, in an embodiment, not all connections of the same degree (e.g., all first-degree connections) may contribute equally to the social proximity score. If the particular member for whom the social proximity score is being derived is connected to a member of the social network service who is employed at the target entity in a decision-making capacity, then the connection may be of greater importance than a first-degree connection to another member employed in a different and less important capacity.

In an embodiment, a social proximity score relative to two people is generated based on connections between the two people in multiple online social networks provided by multiple social network providers. Thus, if two people are connected to each other in multiple social networks, then the corresponding social proximity score would be higher than if the two people were only connected in a single social network.

In an embodiment, an individual's connections with multiple people associated with a target entity are used to generate a single social proximity score for the target entity. For example, a target entity has four decision makers and a first individual has direct connections with three of the four decision makers. A second individual has direct connections with two of the four decision makers. All else being equal, the first individual's social proximity score with the target entity will be higher than the second individual's social proximity score with the target entity. In this example, the SPSs of the first individual with each decision maker are totaled to generate a SPS for the first individual with respect to the target entity.

For example, a direct connection with a decision maker of a target entity is 25. Thus, a SPS for first individual with respect to the target entity may be at least 75, while a SPS for the second individual with respect to the target entity may be at least 50. As another example, the maximum SPS a user may have with an target entity may be 1.0. Since there are four decision makers, then each direct connection with a decision maker is worth 0.25. Thus, a SPS for the first individual with respect to the target entity may be at least 0.75, while a SPS for the second individual with respect to the target entity may be at least 0.5.

### Generating Social Proximity Scores

As described previously, SPS generator 130 generates multiple social proximity scores. SPS generator 130 may be configured to accept an identity of a single individual and an identity of a single person that is associated with a target entity. In response, SPS generator 130 generates a SPS. The identities may be first and last name (and, optionally, other identifying information, such as company name) or social network identifiers that uniquely identity the individual and the person.

If first and/or last names are provided, then multiple people in a social network may share the same name(s). Thus, SPS generator 130 may determine a person from a set of candidate persons that each shares the provided name(s). In an embodiment, SPS generator 130 generates a display that prompts a user (that initiated the SPS generation) to select a particular identity from among a list of person identities. The list may include an image of each person and/or profile information for each person to allow the user to make the appropriate selection.

In a related embodiment, SPS generator 130 is configured to accept an identity of an individual (e.g., a sales representative) and identities of multiple people associated with a target entity. In this way, a user that interacts with SPS generator 130 does not have to provide separate input for each person associated with a target entity.

In a related embodiment, SPS generator 130 is configured to accept an identity of an individual (e.g., a sales representative) and identities of multiple people associated with multiple target entities. For example, user input may specify a social network ID (or member ID) of a sales representative, a list of person (or member) identifiers and, in association with each person identifier, a company identifier. In this embodiment, SPS generator 130 uses the target entity identifier to group (or combine) SPSs of people associated with the same company and, as a result, generate a single SPS for the company relative to the sales representative.

In a related embodiment, SPS generator 130 is configured to accept an identity of an individual (e.g., a sales representative) and an identity of a target entity (e.g., a company name). In response, SPS generator 130 is configured to identify multiple people associated with the target entity and generate a single SPS for the individual relative to the target entity. For example, SPS generator 130 may generate a separate SPS for each identified person associated with the target entity and then combine the SPSs to generate a single SPS.

In a related embodiment, given an identity of a target entity, SPS generator 130 identifies decision makers of the target entity (and ignores other people associated with the target entity) and generates (at least eventually) a single SPS for an individual based on the individual's social proximity to the identified decision makers of the target entity.

In an embodiment, SPS generator 130 is configured to receive a list of individuals (e.g., sales representatives) and a list of target entities (or a list of people associated with at least one of the target entities) to generate a set of SPSs for each individual in the list. In this way, a user provides a single set of input to SPS generator 130 in order to receive all SPSs that are needed as input to solver 150.

### Composing a Program

As described previously, a user creates a program (using client device 140) that indicates multiple social proximity scores and one or more constraints. The social proximity scores may be grouped by individual (e.g., sales representative) or by target entity. Alternatively, each SPS may be associated with (1) individual identification data that uniquely identifies a particular individual and with (2) target entity identification data that uniquely identifies a particular target entity. In this way, the multiple SPSs do not need to be grouped or ordered in any way.

A constraint may be considered a business rule that is translated into a mathematical equation that becomes part of the program submitted to solver 150. A constraint may be specified by a user or may be a default setting. If a program indicates multiple constraints, then some constraints may be user-specified and others may be default constraints.

Without any constraints, one or a few members of a group may be assigned most or all of the available target entities. For example, two sales representatives may be socially connected to decision makers from multiple target companies. The remaining sales representatives may be relatively new or inexperienced, thus generally having lower social proximity scores. Therefore, one or more constraints “force” solver 150 to assign target entities to one or more members that would not normally be assigned many (of any) target entities.

### Constraint: Size of Prize

One example constraint is related to SOP (or size-of-prize). “SOP” refers to the potential value of the set of target entities that is (or might be) assigned to a member. For example, target entity A may have the potential of purchasing $100,000 worth of products or services from a particular company, target entity B may have the potential of purchasing $800,000 worth of products or services from the particular company, and target entity C may have the potential of purchasing $600,000 worth of products or services from the particular company. If there are only two sales representatives in the particular company, then one sales representative should be assigned to target entity B and the other sales representative should be assigned to target entities A and C (assuming the other constraints are satisfied by this assignment).

An SOP constraint may be that the SOP should be approximately equal among all members of a group of members that are to be assigned to different target entities. One purpose of ensuring that SOP is approximately equal among all members of the group is so that each member has a roughly equal opportunity to benefit the organization or company to which the group belongs.

If the constraint requires the same SOP for each member, then a result may not be possible or helpful since such a constraint may become the dominant factor in assigning target entities to group members. The constraint may or may not indicate what “approximately equal” means. For example, an SOP constraint may specify a percentage value (e.g., 5%) indicating that the difference between the SOPs of any two group members should not be any greater than 5% of the lower SOP. As another example, an SOP constraint may indicate a minimum SOP below which no group member should have or a maximum SOP above which no group member should have.

### Constraint: Purchase Likelihood

Another example constraint is a target entity's likelihood of purchasing of product or service that the group members are selling. This likelihood is referred to herein as “purchase likelihood.” A purchase likelihood may be any value, such as a percentage (e.g., 25%) or a score (e.g., 34) that may be normalized. A purchase likelihood may be based on one or multiple factors, including any activities that a target entity (or any of its decision makers) have engaged in and that indicate that the target entity may make another purchase. Example activities may include a number of times the target entity has purchased or used the product/service in the past, a number of times the target entity has been contacted about the product/service, a period of time since the target entity has first been targeted or otherwise informed about the product/service.

As a specific example, a product/service may be product provided by a social network provider and a target entity's purchase likelihood is a measure of the target entity's (or one or more decision makers′) activity with respect to the social network provider. Example social network providers include LinkedIn, Facebook, and Google+. In the context of social networks, multiple factors that may go into generating a target entity's purchase likelihood include a number of social network connections a decision maker has, a number of social network connections the decision maker has to other decision makers, how often the decision maker updates one of his/her social network profiles, how often the decision maker is sharing insights using the social network service provided by the social network provider, and how often the decision maker is using the social network service to perform searches for sales people.

Generally, a target entity's purchase likelihood may be how often the target entity (or its decision makers) use a product or service provided by the entity that makes the product or service that the group members are selling. The product or service used by a target entity (or its decision makers) may be different than the product or service that the group members are selling.

After a target entity assignment is made, the target entities assigned to a group member are identified and the corresponding purchase likelihoods are totaled to generate a single purchase likelihood. The constraint may be that, after an assignment is made, the purchase likelihood associated with each group member should be approximately equal to the purchase likelihoods associated with each other group member. One purpose of ensuring that purchase likelihood is approximately equal among all members of the group is so that each member has a roughly equal opportunity to benefit the organization or company to which the group belongs.

The constraint may or may not indicate what “approximately equal” means. For example, a purchase likelihood constraint may specify a percentage value (e.g., 5%) indicating that the difference between purchase likelihoods of any two group members should not be any greater than 5% of the lower purchase likelihood. As another example, a purchase likelihood constraint may indicate a minimum purchase likelihood below which no group member should have or a maximum purchase likelihood above which no group member should have.

### Constraint: Target Entity Type

Another example constraint is related to types of target entities. For example, if there are ten sales representatives and twenty technology customer accounts, then each sales representative will be assigned at least two technology customer accounts, no fewer than one technology customer account, and/or no more than three technology accounts. Other example types that a target entity may be classified include medical, insurance, charitable, environmental, governmental, and educational.

### Constraint: Geography

Another example constraint is related to geography. For example, 75% of all target entities that will be assigned to any particular member are in the same time zone as the particular member. As another example, each target entity must be assigned to a group member that lives within one hundred miles of the target entity. Such example constraints may be useful to ensure that travel time and expenses are kept to a relative minimum and that each member is burdened roughly the same. Geographic information of a target entity and/or group members may be indicated in the program that is submitted to solver 150 or may be retrieved in a profile maintained by social network system 110.

### Constraint: Number of Target Entities

Another example constraint is related to the number of target entities that are assigned to group members. For example, if there are ten sales representatives and one hundred customer accounts, then each sales representative is assigned roughly ten customer accounts. The program that is submitted to solver 150 may indicate an acceptable range or minimum/maximum number of target entities for any group member. Given the above example where there is a ratio of one group member for every ten target entities, the program may indicate that (a) no group member may be assigned more than twelve target entities, (b) no group member may be assigned less than eight target entities, or (c) no group member is to be assigned three target entities more than any other member in the group.

### Constraint: Loyalty

Another example constraint is a loyalty constraint. A “loyalty” constraint indicates that one or more target entities are essentially “pre-assigned” to a particular group member. Therefore, even though SPS may be generated for the one or more target entities with respect to other members of the group, it is guaranteed that no other member of the group will be assigned to any of the one or more target entities. A loyalty constraint may be useful when a particular group member has had success interacting with the one or more target entities in the past and it would be prudent to maintain those relationships.

### Example Program

The following is an example program framework in AMPL that involves three constraints: SOP, SPS, and purchase likelihood (referred to below as “SSI”):

# formulate
set Rep; # set of reps
set Acct; # set of accounts
param sop {a in Acct}; # SOP for each account
param ssi {a in Acct}; # SSI for each account
param sps {a in Acct, r in Rep} ; # SPS for each pair
## param for each box
param acct_to_assign_lower integer;
param acct_to_assign_upper integer;
param sum_ssi_upper integer;
param sum_ssi_lower integer;
param sum_sop_upper integer;
param sum_sop_lower integer;
## END
var sum_sop {r in Rep};
var sum_ssi {r in Rep};
var subtotal_spi {r in Rep};
var subtotal_act {r in Rep} integer;
var X {a in Acct, r in Rep} binary;
maximize Total_SPS: sum {a in Acct, r in Rep} sps[a, r] * X[a, r];
subject to SUMSSIu {r in Rep}: sum {a in Acct} ssi[a] * X[a, r] <=
sum_ssi_upper;
subject to SUMSSI1 {r in Rep}: sum {a in Acct} ssi[a] * X[a, r] >=
sum_ssi_lower;
subject to SUMSOPu {r in Rep}: sum {a in Acct} sop[a] * X[a, r] <=
sum_sop_upper;
subject to SUMSOP1 {r in Rep}: sum {a in Acct} sop[a] * X[a, r] >=
sum_sop_lower;
subject to SUMASGu {r in Rep}: sum {a in Acct} X[a,r] <=
acct_to_assign_upper;
subject to SUMASG1 {r in Rep}: sum {a in Acct} X[a,r] >=
acct_to_assign_lower

“ASG” refers to total number of accounts assigned to a representative. The “u” in “SUMSSIu” “SUMSOPu” and “SUMASGu” refers to an upper bound while the “l” in “SUMSSIl” “SUMSOPl” and “SUMASGl” refers to a lower bound. In this example program, total SPS is maximized subject to the six constraints specified at the end of the program.

### Assignment Result

Solver 150 analyzes a program sent from client device 140 (or social network system 110) and generates an “assignment result” that indicates an association between each target entity and a (e.g., at most one) member of a group. Solver 150 may rely on data referenced in the program or by the program. For example, while analyzing program, solver 150 may retrieve some data (e.g., geographic data) from social network system 110 or another source.

A person reviewing the assignment result may or may not follow through with making the assignments. Thus, an assignment result serves as a suggestion or recommendation. For example, a leader of a sales team who is responsible for assigning team members to various customer accounts uses an assignment result as a starting point and makes one or more changes to the assignments based on the leader's own personal knowledge. For example, there may be some factors (such as personality traits of, or travel restrictions associated with, a sales team member) that are difficult or impossible to reflect in a program constraint.

The computing device that submitted the program to solver 150 may receive the corresponding assignment result. Alternatively, solver 150 may be configured to transmit an assignment result to a computing device (or system, such as a third party storage service) that is different than the computing device that submitted the corresponding program. Alternatively still, solver 150 may be configured to store an assignment result in persistent storage that client device 140 (or other device not depicted in FIG. 1) accesses at a later time.

An assignment result may be stored as a structure document, such as an XML document or a HTML document. An assignment result may be provided in one or more ways. For example, an assignment result may be displayed in web page rendered by a web browser executing on client device 140.

An assignment result may include multiple data items, such as a list (or indication of a list) of target entities for each group member. For example, a selectable icon is displayed adjacent to each group member indicated in a web page. Selection of an icon adjacent to a particular member name or identifier causes an entire (or partial) list of identities of the target entities that are assigned to the particular member.

The assignment result may also indicate, for a particular member, a social proximity score for each target entity to which the particular member is assigned. For some target entities, an assignment result may indicate multiple social proximity scores associated with multiple members. For example, an assignment result may indicate that target entity A is assigned to member M and a first social proximity score generated for member M relative to target entity A. However, the assignment result may simultaneously indicate (e.g., after selecting an icon associated with member M) a second social proximity score generated for member N relative to target entity A. The second social proximity score may be higher relative to the first social proximity score due to one or more of the constraint(s) specified in the program. However, a reviewer of the results may use this (and other) information to finally assign target entity A to member N (or to another member or potential member).

### Holdout Target Entities

In an embodiment, a constraint that a program specifies is that, of the target entities, one or more target entities will not be assigned to any member of the group. Thus, an assignment result from solver 150 will not assign any group member to any of one or more target entities. Such target entities are referred to herein as “holdout target entities.” One reason for specifying one or more holdout target entities is in anticipation that the assigning organization (e.g., sales team) intends to have one or more people eventually join the organization and be responsible for the holdout target entities.

For example, a program may indicate a number of target entities that are not to be assigned. Therefore, solver 150 ensures that an assignment result generated based on executing the program does not assign (or otherwise associate) that number of target entities to any member in a group.

As another example, a program may indicate a number of members of the group and a number of placeholder members reflecting, e.g., known or unknown people that are to be hired. Solver 150 determines the number of holdout target entities based on the ratio of the number of members to the number of placeholder members and any relevant constraints (such as each member being assigned an approximately equal number of target entities). Thus, solver 150 ensures that there are holdout target entities so that future members may be assigned to those target entities.

### Recruiting

Techniques described herein may be used to identify one or more individuals who are not yet “official” members of the group (e.g., sales team). In an embodiment, one or more individuals in a group of members that are to be assigned to target entities are individuals who are not yet employed by the assigning organization. Such individuals are referred to herein as “potential members.” For example, there are three members of a group: member A, member B, and potential member C, where members A and B are part of a sales team of a company, but potential member C is not yet part of the sales team and may not even be employed yet by the company. However, member C is being recruited by the company and may prove to be a valuable member of the sales team. A leader of the sales team may desire to see how target entities may be assigned if member C is part of the sales team. In this example, social proximity scores would be generated for each of members A-C relative to each target entity and the generated social proximity scores would be input to the program submitted by client device 140 to solver 150.

In a related example, multiple variations of a program may be created and then analyzed by solver 150. Each variation includes a different set of one or more potential members of the group. For example, a company has one hundred customer accounts and would like to assign ten different sales representatives to the customer accounts. However, the company currently employs only eight sales representatives. The company is currently open to hiring two more sales representatives. The company may have identified six potential candidates to fill the two vacancies, which candidates may not even know anything about the company. Therefore, there are twelve (6*2) different combinations of two candidates that might join the sales team. Therefore, twelve different variations of a program are created and then analyzed by solver 150. Each variation is identical (e.g., same objective to maximize SPS, same constraints, same SPSs for the current eight sales representatives) to each other variation except for the set of SPSs generated for each possible combination of two candidates. The assignment result (from solver 150) that has the highest aggregated social proximity score may be selected as the final result for purposes of customer account assignments.

### Target Entity Assignment as a Service

In an embodiment, one party that desires to assign target entities to group members uses the services of another party that owns or operates SPS generator 130 and provides a result generated by solver 150. For example, company A provides, to a particular entity, first group information that identifies members of company A, first target entity information that identifies multiple customer accounts associated with company A, and one or more constraints. The particular entity operates SPS generator 130 and client device 140, identifies an assignment result generated by solver 150, and provides the assignment result to company A. Similarly, company B provides, to the particular entity, second member information that identifies members of company B, second target entity information that identifies multiple customer accounts associated with company B, and one or more constraints. The particular entity operates SPS generator 130 and client device 140, identifies an assignment result generated by solver 150, and provides the assignment result to company B.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

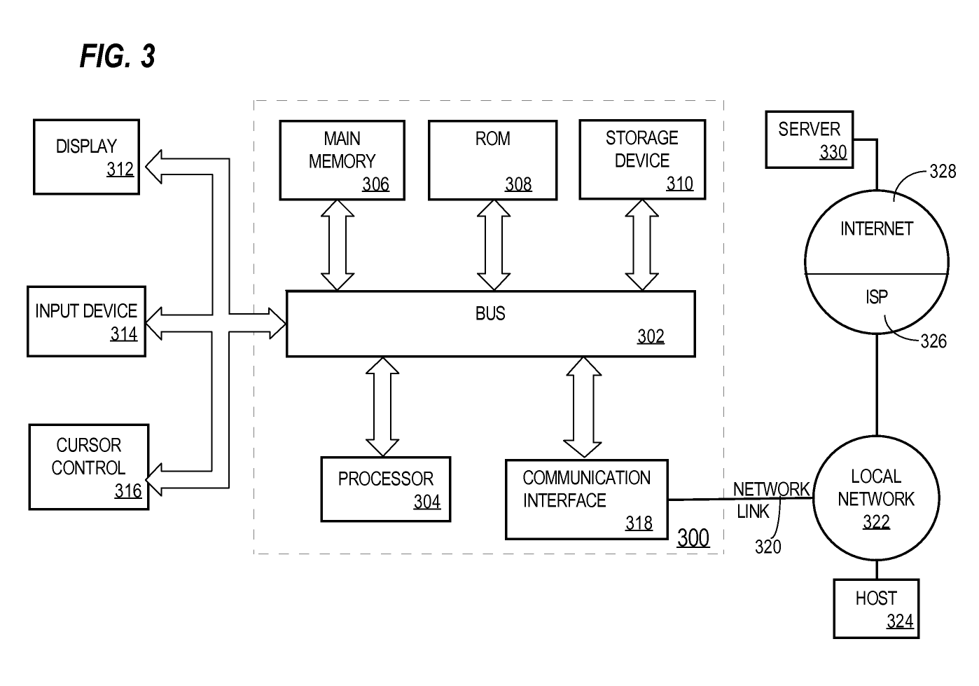

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
identifying a plurality of sets of social proximity scores, wherein each set in the plurality of sets is associated with a different member of a group of members;
wherein, for each member in the group, each social proximity score in a set of social proximity scores corresponding to said each member is associated with a different target entity of a plurality of target entities;
generating a program that indicates the plurality of sets of social proximity scores and includes one or more constraints that are to be satisfied;
sending the program to a solver that analyzes the program and generates a result;
wherein the result indicates, for each target entity of the plurality of target entities, an association between said each target entity and a member in the group;
wherein the method is performed by one or more computing devices.

2. The method of claim 1, wherein:
the program seeks to maximize, in the result, social proximity scores of members in the group relative to the plurality of target entities;
in the result, each target entity is associated with no more than one member in the group.

3. The method of claim 1, wherein:
in the result, each member in the group is associated with multiple target entities of the plurality of target entities;
the multiple target entities associated with each member in the group is associated with a monetary value;
the one or more constraints indicate that, in the result, a monetary value associated with one member in the group approximately equals the monetary value associated with each other member in the group.

4. The method of claim 1, wherein the one or more constraints indicate that, in the result, a number of target entities that are associated with one member in the group approximately equals the number of target entities associated with each other member in the group.

5. The method of claim 1, wherein:
each member in the group and each target entity of the plurality of target entities is associated with a geographical location;
in the result, each member in the group is associated with multiple target entities of the plurality of target entities;
the one or more constraints indicate that, in the result, the geographical location associated with each member in the group is geographically near at least a subset of the target entities that are associated with said each member.

6. The method of claim 1, wherein:
each target entity in the plurality of target entities has a type;
a first target entity in the plurality of target entities is of a first type;
a second target entity in the plurality of target entities is of a second type that is different than the first type;
the one or more constraints indicate that, in the result, each member in the group is associated with an approximately equal number of target entities of the second type.

7. The method of claim 6, wherein target entities of the second type are classified as technology companies and target entities of the first type are not classified as technology companies.

8. The method of claim 1, wherein the group of members is a first group of members of a first party and the plurality of target entities are a first plurality of target entities, the method further comprising:
identifying a second plurality of sets of social proximity scores, wherein each set in the second plurality of sets is associated with a different member of a second group of members of a second party that is different than the first party;
wherein, for each member in the second group, a second set of social proximity scores corresponding to said each member includes a social proximity score that is associated with a different target entity of a second plurality of target entities that are different than the first plurality of target entities;
generating a second program that indicates the second plurality of sets of social proximity scores and includes one or more second constraints that are to be satisfied;
sending the second program to the solver that analyzes the second program and generates a second result;
wherein the second result indicates, for each target entity of the second plurality of target entities, an association between said each target entity and a member in the second group.

9. The method of claim 1, wherein:
the plurality of target entities is a strict subset of a second plurality of target entities;
for each member in the group, each social proximity score in the set of social proximity scores corresponding to said each member is associated with a different target entity of the second plurality of target entities;
the program indicates that one or more target entities in the second plurality of target entities are not to be associated with any member in the group;
the result does not associate any of the one or more target entities with any member in the group.

10. The method of claim 1, wherein a first set of members in the group are employed by a particular company and a second set of one or more members in the group are not employed by the particular company.

11. The method of claim 1, wherein the program is composed in a mathematical programming language.

12. The method of claim 1, further comprising:
prior to identifying the plurality of sets of social proximity scores, sending, to a social proximity score generator, a first list of identities of members of the group and a second list of identities of the plurality of target entities;
after sending the first list and the second list to the social proximity score generator, receiving, from the social proximity score generator, the plurality of sets of social proximity scores.

13. The method of claim 12, wherein the social proximity score generator is part of a social network service that is provided by a party that performs the method of claim 1.

14. A system comprising:
one or more processors;
one or more storage media storing instructions which, when executed by the one or more processors, cause:
identifying a plurality of sets of social proximity scores, wherein each set in the plurality of sets is associated with a different member of a group of members;
wherein, for each member in the group, each social proximity score in a set of social proximity scores corresponding to said each member is associated with a different target entity of a plurality of target entities;
generating a program that indicates the plurality of sets of social proximity scores and includes one or more constraints that are to be satisfied;
sending the program to a solver that analyzes the program and generates a result;
wherein the result indicates, for each target entity of the plurality of target entities, an association between said each target entity and a member in the group.

15. The system of claim 14, wherein:
the program seeks to maximize, in the result, social proximity scores of members in the group relative to the plurality of target entities;
in the result, each target entity is associated with no more than one member in the group.

16. The system of claim 14, wherein:
in the result, each member in the group is associated with multiple target entities of the plurality of target entities;
the multiple target entities associated with each member in the group is associated with a monetary value;
the one or more constraints indicate that, in the result, a monetary value associated with one member in the group approximately equals the monetary value associated with each other member in the group.

17. The system of claim 14, wherein the one or more constraints indicate that, in the result, a number of target entities that are associated with one member in the group approximately equals the number of target entities associated with each other member in the group.

18. The system of claim 14, wherein:
each member in the group and each target entity of the plurality of target entities is associated with a geographical location;
in the result, each member in the group is associated with multiple target entities of the plurality of target entities;
the one or more constraints indicate that, in the result, the geographical location associated with each member in the group is geographically near at least a subset of the target entities that are associated with said each member.

19. The system of claim 14, wherein:
each target entity in the plurality of target entities has a type;
a first target entity in the plurality of target entities is of a first type;
a second target entity in the plurality of target entities is of a second type that is different than the first type;
the one or more constraints indicate that, in the result, each member in the group is associated with an approximately equal number of target entities of the second type.

20. The system of claim 14, wherein the group of members is a first group of members of a first party and the plurality of target entities are a first plurality of target entities, the method further comprising:
identifying a second plurality of sets of social proximity scores, wherein each set in the second plurality of sets is associated with a different member of a second group of members of a second party that is different than the first party;
wherein, for each member in the second group, a second set of social proximity scores corresponding to said each member includes a social proximity score that is associated with a different target entity of a second plurality of target entities that are different than the first plurality of target entities;
generating a second program that indicates the second plurality of sets of social proximity scores and includes one or more second constraints that are to be satisfied;
sending the second program to the solver that analyzes the second program and generates a second result;
wherein the second result indicates, for each target entity of the second plurality of target entities, an association between said each target entity and a member in the second group.
